(19) United States
(12) Patent Application Publication
(10) Pub. No.: US 2010/0124636 A1
(43) Pub. Date: May 20, 2010

(54) THREE-DIMENSIONAL BUBBLE PACKAGING

(76) Inventors: Daniel J. Gibson, Zeeland, MI (US); Patrick R. Patten, West Olive, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/272,958

(22) Filed: Nov. 18, 2008

(51) Int. Cl. B32B 3/12; B65B 31/00

(52) U.S. Cl. 428/178; 53/79

(57) ABSTRACT

A bubble pack comprises sheet product with elongated bubbles separated in one direction by weld lines for folding and separated in another direction by strips about half a width of the bubbles. A first portion of the sheet product is formed into a sleeve and a second portion slit to form flaps for tucking inside the sleeve portion to support, protect and separate 1^{st} and 2^{nd} vehicle mirrors with their stem mounts overlapped in a densely stored arrangement. The mirrors and stem mounts are separated and protected by bubbles of the sheet. One flap forms a vertical support adapted to support a weight of the product's laterally-extending stems and additional flaps folded into the sleeve separate the product from each other. The bubbles shift and expand during the packing process in ways that “glove” onto the product for cushioned and secure non-scratching protection of the product.

### BACKGROUND

The present invention relates to bubble pack arrangement for shipping articles.

Modem competition makes it important that manufacturers minimize shipping and packaging costs, while providing optimal scratch resistance and anti-damage support to product being shipped. This is especially important for highly visible items, such as interior rear view mirrors in vehicles which end up just inches from a driver's head. Recently, consumers and companies have also recognized that it is important to use “green” (environmentally-friendly) materials that, among other things, can be recycled and/or reused and/or disposed of in a “green” environmentally-friendly manner. The term “green” also can be used to imply that the original manufacture of packaging must be environmentally friendly, such as through its production being non-damaging and non-polluting to the environment. However, many materials often used in shipping are not particularly “green”. For example, foam materials (often used in packaging, such as foam “peanuts” placed in boxes to cushion shipped products and/or sheets/pieces of foam) are not very “green” since they are non-recyclable and their original manufacture uses environmentally-unfriendly ingredients and processes. Corrugated cardboard is also often used in packaging, but cardboard is surprisingly abrasive and can scratch product, and further it does not provide as soft of cushioning as may be desired for many products. Further, foam and cardboard can be difficult and expensive to return and/or recycle and/or dispose of. For example, where they are used to ship product into large cities, the shipping materials must be carried away as part of the delivery. This often requires that the shipping truck haul in the product, then leave (since they can't just wait around in congested cities), and return to pick up the shipping materials. Further, recycling and/or disposal is not “green”, as discussed above.

Materials are often combined to arrive at packaging with particular characteristics, such as by using foam sheets or foam “peanuts” to protect easily-damaged product, and cardboard for structure, support, and containment. However, combinations of materials have assembly costs and further they often do not solve the problem of non-green materials, such as those problems noted above. Bubble pack sheets and wraps can provide good non-abrasive support to product, but they are so flexible and cumbersome to deal with that they can be difficult to use. Further, there is a tendency to include too much of them in shipping, making it difficult to efficiently and effectively use them. Further, their use can result in substantial waste as it is wrapped excessively around product.

### SUMMARY OF THE PRESENT INVENTION

In one aspect of the present invention, an article for shipping first and second non-uniformly-shaped packed product in a dense overlapped shipping arrangement, includes a sheet product having a spaced array of bubbles therein, the sheet product being formed into a sleeve with at least one integral longitudinally-extending first flap that can be tucked inside the sleeve to form a vertical support structure for supporting a laterally-extending part of the first packed product, and a second flap configured to protect and separate the second packed product from the first packed product in a dense overlapped packed arrangement in the sleeve.

In another aspect of the present invention, an article for shipping non-uniformly shaped product with an extending stem includes a sheet product defining a sleeve, and at least one bent flap inside the sleeve to define a vertical support structure within the sleeve for the extending stem, with sections of the bent flap each including bubbles, for supporting product in the sleeve in an overlapped densely stored arrangement.

In another aspect of the present invention, a method of making an article for shipping includes steps of providing a sheet having an array of bubbles therein, slitting a first portion of the sheet to define longitudinal flaps and not slitting a second portion, forming the second portion into a tubular sleeve, and tucking at least one of the flaps into the tubular sleeve to form a bent vertical support structure for receiving and supporting stored product, the bent vertical support structure including bubbles on each side and having sufficient structure to support a lateral stem extending from the stored product.

In another aspect of the present invention, a method of packing product for shipping includes steps of providing a bubble sheet with a first portion defining a sleeve and a second portion forming flaps that can be folded into the sleeve; at least a first one of the flaps being positioned in the sleeve to define a support structure adapted to support a stem extending laterally from the product, placing a first product into the sleeve with an associated stem of the first product resting on the support structure, folding a second one of the flaps onto the associated stem of the first product, and placing a second product into the sleeve with an associated stem of the second product resting on the support structure and positioned generally adjacent the stem of the first product but separated therefrom by the second flap.

In another aspect of the present invention, a packaging article includes two layers of sheet material bonded together along continuous longitudinal and transverse weld lines to define an array of air-containing bubbled areas separated on at least one side by non-bubbled strips, with at least one of the longitudinal and transverse weld lines each including one of the bubbled areas on one side and a non-bubbled area on an opposite side, with the non-bubbled strips facilitating folding. A first portion of the sheet is formed into a sleeve and a second portion of the sheet is slit to form flaps that fold into the sleeve to support product for shipment.

In a narrower aspect, the bubbled areas and the non-bubbled strips are elongated, and also the non-bubbled strips are about half a width of the bubbled areas.

An object of the present invention is to provide an article for shipping formed from a bubble pack sheet and having integral flaps that can be folded and formed to support product in a dense overlapped arrangement, even when the product has a laterally-extending stem.

An object of the present invention is to provide an article for shipping stored product where bubble sheeting includes a V-shaped support structure within a sleeve, the V-shaped support structure supporting laterally-extending stems extending from two of the stored product in an overlapped arrangement.

An object of the present invention is to provide an article for shipping stored product where a first part of a sheet is formed into a sleeve and a second part is slit to form foldable integral flaps that can be used to both divide the sleeve into pockets and also cushion product stored therein.

These and other aspects, objects, and features of the present invention will be understood and appreciated by those skilled in the art upon studying the following specification, claims, and appended drawings.

### BRIEF DESCRIPTION OF DRAWINGS

FIG. 1 is a plan view of a sheet on a second sheet, prior to incorporating bubbles, but showing an overall shape of a blank.

FIG. 2 is a plan view of a sheet product that includes an array of elongated bubbles formed therein, separated by non-bubbled strips on their long sides.

FIG. 3 is a plan view of the bubble sheet product of FIG. 2 but with slits defining four flaps, the bubbles not being shown in order to better show details of the slits.

FIG. 4 is perspective view of the bubble sheet product of FIG. 3 but with a first half formed into a sleeve and with the longitudinal flaps hanging from an end of the sleeve, and FIG. 4A is a perspective identical to FIG. 4 but more schematically drawn to help show positions of the sleeve and flaps.

FIGS. 5-8 are perspective views of the bubble sheet product as flaps are sequentially folded into the sleeve for cushioning product positioned therein.

FIGS. 6A, 7A, 8A and 8B are cross sections taken along lines 6A-6A in FIG. 6, 7A-7A in FIG. 7, and 8A-8A and 8B-8B in FIG. 8.

FIGS. 9-16 (including FIGS. 11A-15A, and 13B-15B) are perspective views illustrating sequential positions of flaps when packing mirrors into the sleeve portion, including some mirrors packed therein.

FIG. 17 is a perspective view illustrating an arrangement of ten bubble sheet articles secured together and arranged within a cardboard box, and FIG. 18 illustrates the ten articles secured together as a subassembly prior to placement in the box.

### DETAILED DESCRIPTION OF PREFERRED EMBODIMENTS

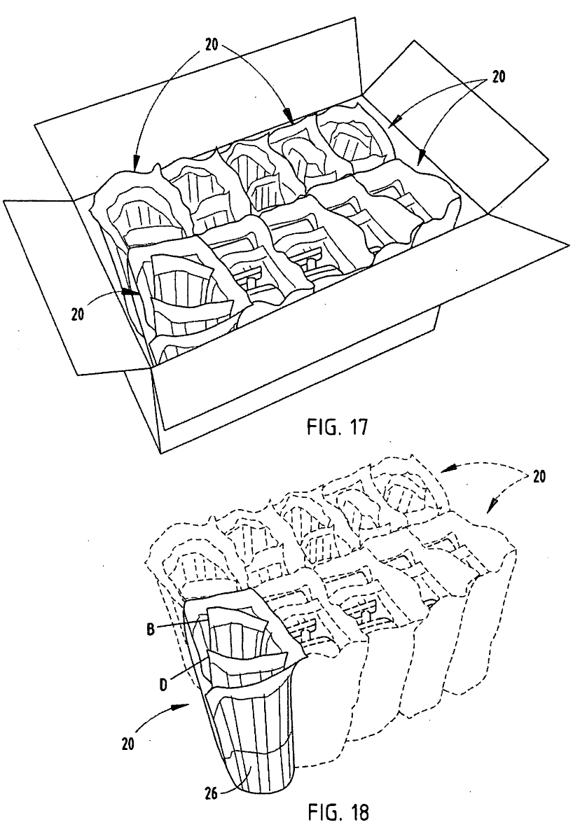

A bubble pack 20 (FIGS. 17-18) comprises sheet product 21 (e.g. polyethylene sheet) with elongated bubbles 22 separated in one direction by single weld lines 23, and separated in another direction by double weld lines 23 forming non-bubbled spacer strips 24 between the bubbles. It is contemplated that the bubbles 22 can be arranged in a variety of different configurations. The illustrated sheet product is slightly greater than four bubble-lengths tall and about 16-18 bubble widths wide. The illustrated strips 24 are about half a width of the bubbles 22, and the bubbles are about four to eight times (or more preferably about five to six times) as long as they are wide.

The weld lines form natural bend lines around and between the bubbles 22 when bending the sheet product 21. A first half portion 26 of the sheet product 21 is formed into a sleeve and a second half portion 27 is slit to form integral flaps A, B, C, D. The integral flaps can be tucked inside the sleeve portion 26 to support, protect and separate 1^{st} and 2^{nd} vehicle mirrors G and H with their stem mounts G′ and H′ overlapped in a densely stored arrangement within the sleeve portion 26. The flaps A and C support the mirrors, while the flaps B and D separate the mirrors G, H and hold apart their respective mounting stem G′, H′, with the mirrors and stems being separated and protected by bubbles 22 of the sleeve portion 26 and bubbles 22 of the flaps A, B, C, D.

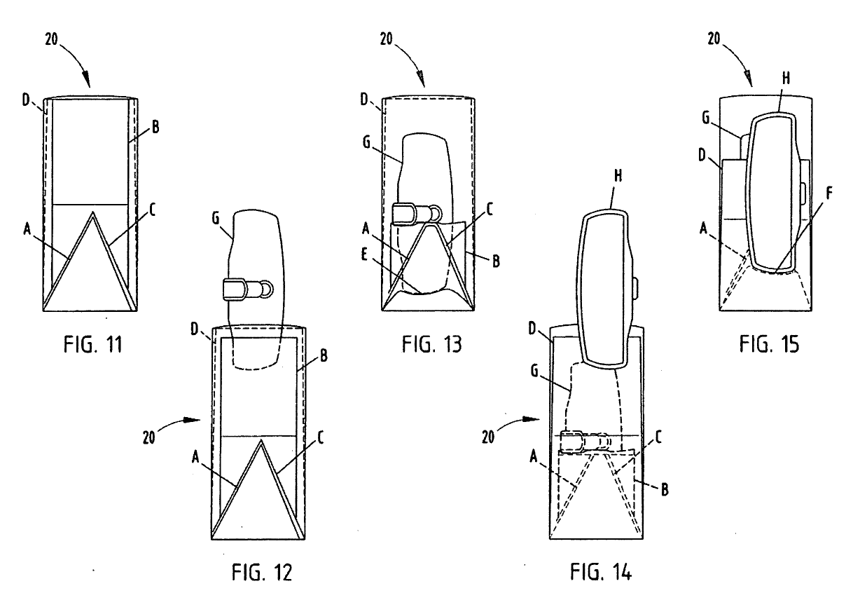

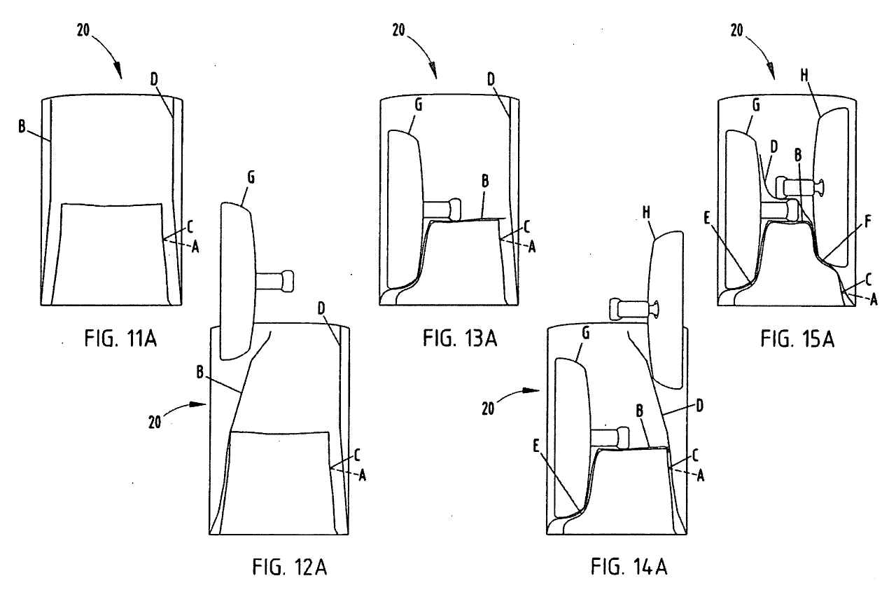

Two flaps A and C (or one flap A) are bent along their mid-level weld line 23 and then folded into the sleeve portion 26 to form a tent-like vertical support (also called “V-shaped support structure”). (See FIGS. 8B and 11.) Due to the two-high bubble length of the flaps A and C and their mid-level weld lines, one set of the bubbles of the flap A (and of the flap C) ends up on each side of the tent-like support structure formed by the bent flap(s). This results in a vertical support structure that is stable and able to support significant weight. For example, in the illustrated arrangement, the vertical support structure of bent flaps A and C are able to support a total weight of the products G and H, including their laterally-extending stems G′ and H′. Additional flaps B and D are folded into the sleeve portion 26 during packing to separate the products G and H from each other. For example, the product G is supported on flap B by folding the flap B onto a top of the tent-like vertical support of flaps A and C, and by placing the first product G into the sleeve with its stem G′ resting on the flap B. The flap D is then folded onto the mounting stem G′, and the second product H is placed into the sleeve with its stem H′ resting on the flap D. Notably, the bubbles 22 shift and expand in some areas while contracting in other areas during the packing process, especially as the second product H is placed into the sleeve.

As product G and H are placed into the sleeve, the bubbles 22 compress and shift against the product G and H. This causes the bubble pack 20 to “glove” onto the product, because the two products G and H within the bubble pack 20 are tightly held by compression of the bubbles against the mirrors. This results in a tightly cushioned and very secure non-scratching protection arrangement that is highly desirable for shipping and storing purposes. Any movement or stress on the product is compensated for by an equal movement or cushioning action of the packing material. Mechanical shocks during shipment are greatly dampened and distributed. There is substantially no scuffing or abrasive action between the packed product and the shipping packaging material because of give and take by the bubble pack material due in part to the softness and flexibility of the bubble pack material. Further, the bubble pack substantially forms the entire support structure for the packed product, thus leading to a packaging that is extremely “green” by being completely reusable and/or recyclable and/or easily disposed of in an environmentally-friendly “green” manner.

It is contemplated that many manufacturers will want to use a cardboard box to contain a multi-cell arrangement of the present bubble pack articles. In such case, the bubble packs are easily placed into (or removable from) the box, and further the cardboard box can be made collapsible for compact shipment away from the site where product is unpacked.

The material of the sheet product is a polymeric material that is relatively easily formed and easily bonded, such as thin sheet polyethylene or even polypropylene. Such materials are well known in the art, and need not be described in detail for an understanding of the present invention by a person skilled in this art. It is contemplated that a wide variety of different sheet materials can be used in the present invention, with a selection of the material being driven by functional requirements of the packing, as well as by compatibility with the product being packed, recyclability, and the like considerations.

It is contemplated that the bubble size, spacing and arrangement can be varied to adapt to particular product and particular functional requirements. The illustrated bubbles 22 have a particular size and shape and spaced arrangement chosen to assist in their ability to fold along a desired line and also to form self-supporting structure for the sleeve portion 26 and for the bent vertical support structure to be self-supporting and product-supporting when supporting mirrors. The illustrated bubbles 22 have the following dimensions: 5″ length×1¼ width. The non-inflated strips 24 have the following dimensions: 5″ length×½″ width. The weld lines have the following width dimension: 1/16″ to ⅛″.

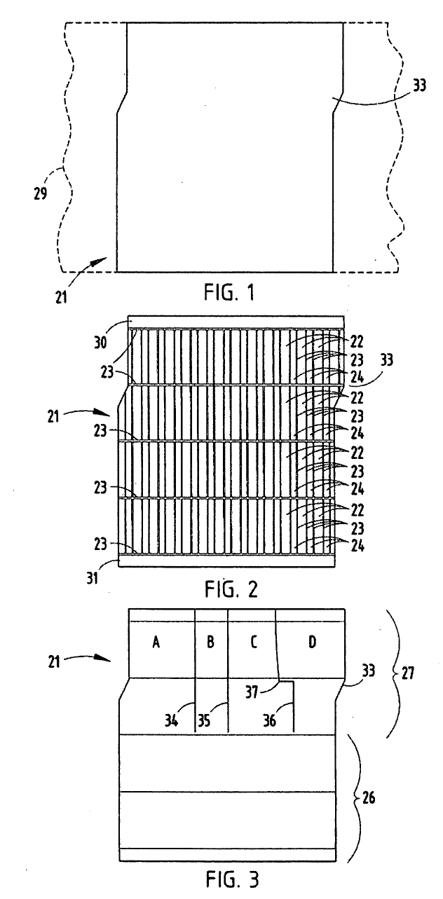

It is contemplated that the sheet size and shape can be varied to adapt to particular product and particular functional requirements. The illustrated sheet product 21 is cut from a continuous band 29 of bubbled material (FIG. 1) having a width of about 21″ to 22″ inches, with top and bottom excess edge flanges 30 and 31 of about 1¼″ to 1½″ wide being located along edges of the continuous sheet. Between flanges 30 and 31 are four elongated bubbles 22 arranged end-to-end. When the sheet product 21 is cut to form a blank, the edge cut line includes a short straight part extending from flange 30 to just beyond the first bubble 22, an angled offset part that extends across a bubble and a strip at about 30 degrees, and a long second straight part that extends the remaining distance to the flange 31. The same cut is made for both sides of the sheet product 21, such that there is no waste when cutting the sheet product 21 sequentially from the continuous sheet. Notably, the bubbles 22 and welding (i.e. weld lines 23 and non-bubble strips 24) are preferably formed in the sheet product prior to the cuts being made, although they could be made thereafter. The bubbles 22 are omitted from FIGS. 1 and 3 for convenience and to more clearly show a shape of the cut sheet product (FIG. 1) and slit blank product (FIG. 3), but in a preferred form, the bubbles are formed and are present prior to any cutting of the continuous sheet. Notably, the cut line can be made by different means, such as by die cutting, laser cutting, shear cutting, water-jet cutting, etc.

The angled offset cut along the side of the sheet product forms a tab-like flange 33 which ultimately becomes an edge part of the flap D. Three slits 34-36 are cut from flange 30 halfway into the sheet product 21 (i.e. to the weld line at a middle of the blank, FIG. 3), the slits causing the formation of flaps A, B, C, and D. The slits 34-35 are straight lines. A width of the bottom of the flaps A and C are about twice a width of the flaps B and D, so that the sleeve 26 has a desired rectangular shape when flaps A and C are pressed into the sleeve, as described below. The slit 36 includes an offset at its middle, such that it forms a second tab-like flange 37 on flap D opposite the tab-like flange 33. The tab-like flanges 33 and 37 are wider than a shape of the rectangular sleeve, causing them to bend when flap D is pressed into the sleeve 26. This causes the tab-like flanges 33 and 37 to form a U-shaped structure with the remainder of the flap D, creating a pocket that receives and holds the stem G′ (or stem H′) when product G (or H) is placed into the sleeve, as discussed below.

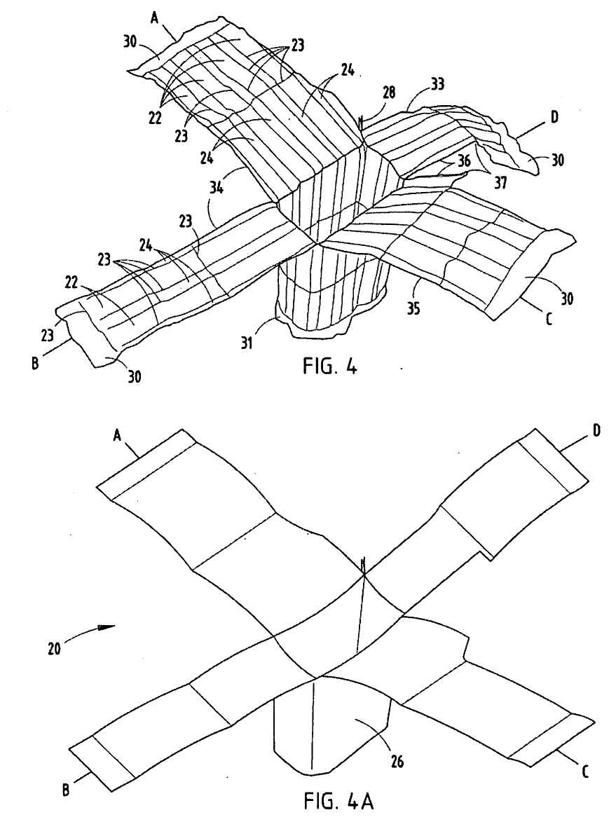

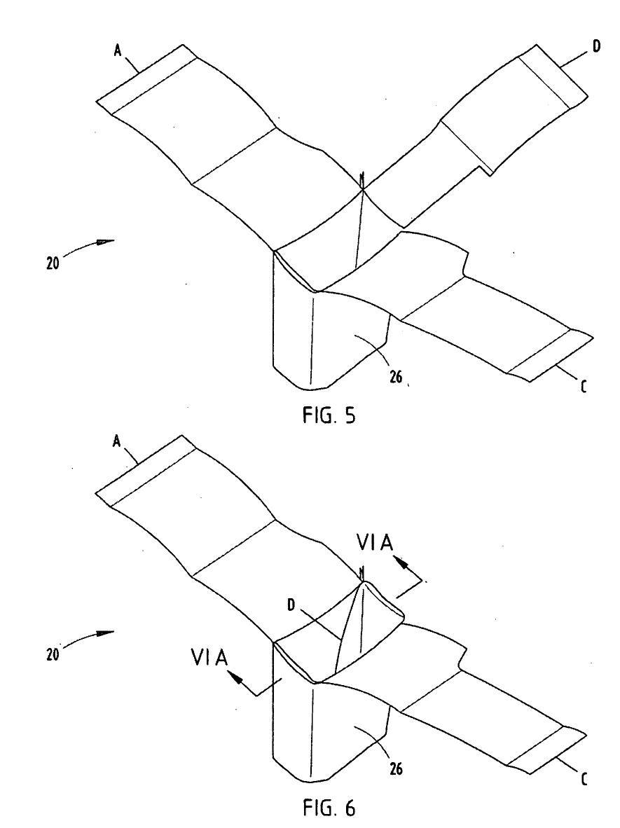

The flanges along edges of the cut sheet are bonded at location 28 (FIG. 4A) together to form the sleeve 26 (FIGS. 4-4A). Once formed, the flaps A, B, C, D extend longitudinally from the sleeve 26. (FIG. 4 illustrates the bubbles, and FIG. 4A is identical to FIG. 4 but has the bubbles 22 eliminated to more clearly show the flaps A, B, C, D, and sleeve 26. For similar reasons, the bubbles 22 are not shown (but are present) in FIGS. 5-16 and 12A-15A. The remaining figures generally show the bubbles.

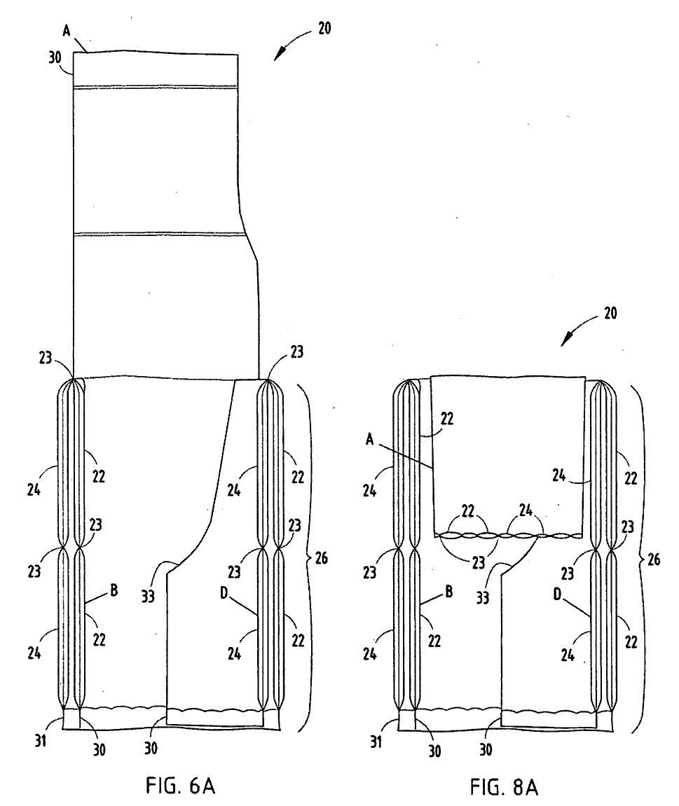

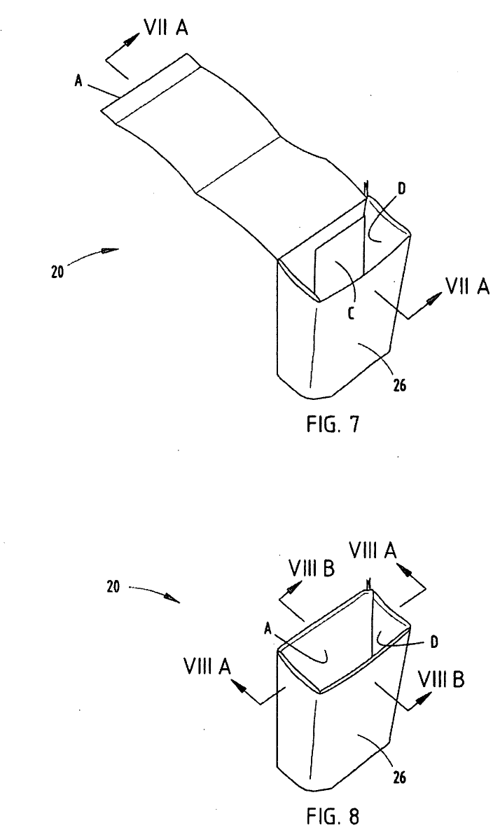

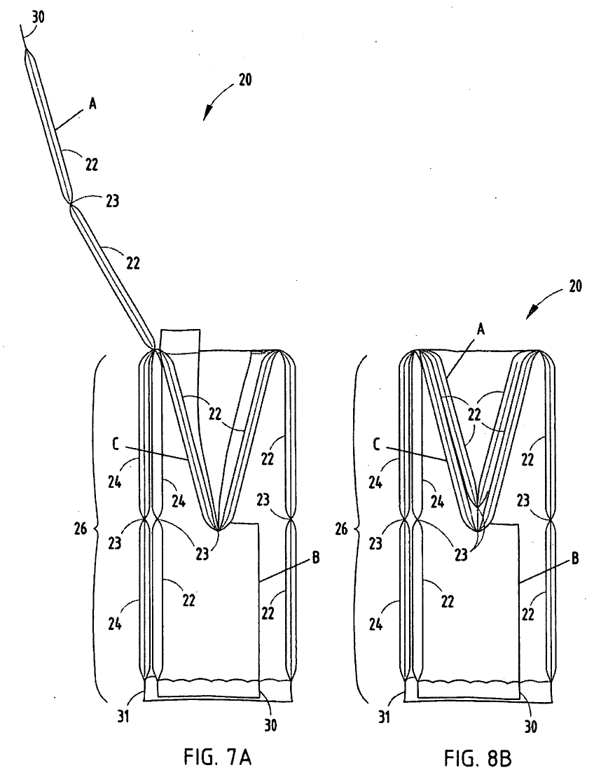

FIGS. 4 and 4A show the sleeve 26 with flaps A, B, C, D extending/hanging outwardly from the sleeve 26. The sleeve 26 in FIGS. 4 and 4A is upside-down (i.e. the bottom is at the top) in order to better show the flaps A, B, C, D. FIGS. 5-6 show that when the flaps B and D are pressed into the sleeve 26, the sleeve 26 takes on a generally rectangular shape. This is due to a narrow width of the flaps B and D, and also due to the weld lines and due to forces that result when the flaps B and D are bent about the weld lines at their connection to the sleeve 26. FIG. 6A shows a position of the bubbles 22 on flaps B and D and bubbles 22 on the adjacent walls of the sleeve 26. FIGS. 7-8 show that when the flaps A and C are pressed into the sleeve 26, the sleeve 26 takes on a slightly more specific generally rectangular shape. This is due to a larger width of the flaps A and C, and also due to the weld lines and due to forces that result when the flaps A and C are bent about the weld lines at their connection to the sleeve 26. Also, the flaps A and C are bent about the weld line 23 at their middle, thus creating structure that further causes a rectangular shape of the sleeve 26. FIGS. 7A, 8A, 8B are cross sections that show a position of the bubbles 22 on flaps A and C and that show a position of bubbles 22 on the adjacent walls of the sleeve 26.

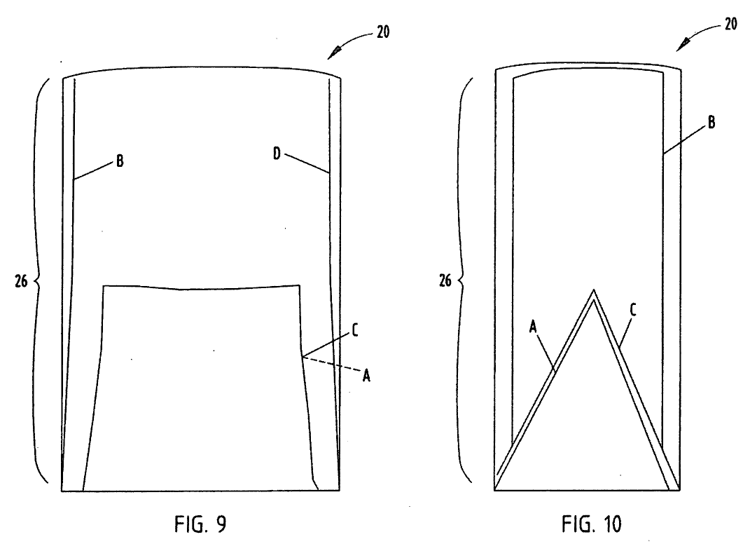

FIGS. 9 and 10 are simplified orthogonal front and side views of the present bubble pack article 20 shown in FIG. 8, but with the article 20 shown as being positioned right-side-up. Although we refer to FIG. 9 as a front view, its name is merely arbitrary.

FIGS. 11-15 are side views showing how the two mirrors (i.e. packed products G and H) are packed into the bubble pack article 20. FIGS. 11A-15A are front views that correspond to FIGS. 11-15. FIGS. 11-11A show the bubble pack article 20 ready for receiving mirror G. FIGS. 12-12A show the mirror G entering a top of the sleeve 26, with a lower end E of the mirror G being located between the flap B and a wall of the sleeve 26. FIGS. 13-13A show the mirror G positioned entirely within the sleeve 26, resting on flap B, with its mounting stem G′ supported by the flap B and flaps A and C. Notably, a tip of the tent-like bent flaps A and C collapses slightly, so that the tip is not so pronounced. Also, compare with FIG. 4, and note that the flap B has two adjacent bubbles 22 with a weld line 23 therebetween. The weld line 23 ends up on the tip of the bent flaps A and C, and its two adjacent bubbles 22 end up on either side of the stem G′, thus providing a more secure resting position of the stem G′. (It is noted that the flap D could be first used instead of B . . . and in such event, the tab-like flanges 33 and 37 would form a cup-like shape for receiving the stem G′, thus providing further stability and security for the stem.

FIGS. 14-14A show a second mirror H entering a top of the sleeve 26, with a lower end F of the mirror H being located between the flap D and a wall of the sleeve 26. FIGS. 15-15A show the mirror H positioned entirely within the sleeve 26, resting on flap D, with its mounting stem H′ supported by the flap D and also flaps A and C (and also flap B). Notably, as mirror G is positioned within the sleeve 26, the bubbles 22 shift and flex to accommodate its position. As the mirror H is positioned entirely within the sleeve 26, the bubbles 22 shift and flex an additional amount. The bubble pack article 20 is configured in size and shape so that upon placement of the second mirror, the bubbles flex and conform to “glove” onto the mirrors G and H, creating a relatively tight and snug supportive pack where bubbles compress against the mirrors. During shipment, the bubbles 26 do not rub and shift relative to the packed product mirrors G and H, but instead the bubbles 26 include thin film “skins” that shift and move with the product. Thus, all stresses are distributed and the product is very well cushioned and insulated from any impacts or other forces. Further, since there is no rubbing, the product is not scratched or abraided.

FIGS. 13B, 14B, and 15B are perspective views of FIGS. 13-15 (and 13A-15A). The FIGS. 13B-15B are perspective top views, with FIG. 13B showing the mirror G in the bubble pack article 20 with the flap B thereunder supporting the stem G′, FIG. 14B showing the flap D bent down onto a top of the stem G′ of mirror G, and FIG. 15B showing the second mirror H positioned in the sleeve 26 with the flap D under the stem H′ of the mirror H.

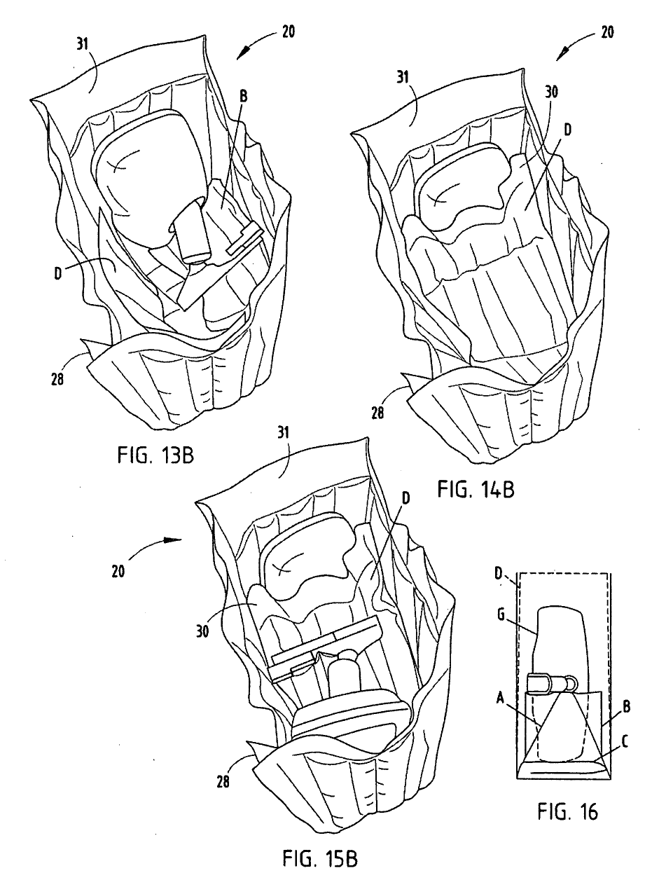

FIG. 16 shows a modified bubble pack article 20′, where only one flap A is pressed into the sleeve 26. The second flap C is doubled-back under a bottom of the sleeve 26 to form a double-cushioned bottom. With this article 20′, the entire package is cushioned by a doubled set of bubbles 22 on the flap C. Testing shows that the first flap A can still be made sufficiently strong to do its intended function of support. Thus, where a manufacturer wants additional bottom cushioning, they would/could use the modified bubble pack article 20′.

The bubble pack articles 20 can be welded together (FIGS. 17-18) to form a self supporting multi-pack arrangement (see FIG. 18). Where additional protection is desired or where a rigid outer shell is desired to facilitate shipping and handling, a box or container (such as a cardboard box) can be used to receive the multi-pack arrangement.

The present bubble pack article is a self-supporting arrangement that fully encloses and holds the product. It provides cushioning as well as non-shearing support to thus eliminate scuffs and abrasive action causing damage to packed product. The material of the bubble sheet has a skin like quality that shifts with the packed mirrors and doesn't rub. Further, the material of the PE film that touches the packed mirrors is softer than structural plastics, allowing softer plastics to be used in mirror housings. Softer plastics are often better suited for use on visible surfaces and for aesthetics, since they are easier to mold and potentially lower cost (versus harder non-scratch plastics). The present bubble pack material is recyclable and/or reusable. For example, it can be reground and re-pelletized for molding of plastic parts or additional bubble packs. It is generally considered to be “green” and environmentally friendly.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is: claimed are defined as follows:

1. An article for shipping first and second non-uniformly-shaped packed product in a dense overlapped shipping arrangement, comprising:
a sheet product having a spaced array of bubbles therein, the sheet product being formed into a sleeve with at least one integral longitudinally-extending first flap that can be tucked inside the sleeve to form a vertical support structure for supporting a laterally-extending part of the first packed product and a second flap configured to protect and separate the second packed product from the first packed product in a dense overlapped packed arrangement in the sleeve.

2. An article for shipping non-uniformly shaped product with an extending stem comprising:
a sheet product defining a sleeve, and at least one bent flap inside the sleeve to define a vertical support structure within the sleeve for the extending stem, with sections of the bent flap each including bubbles, and when bent being configured to support two of the product in the sleeve in an overlapped densely stored arrangement.

3. A method of making an article for shipping comprising steps of:
providing a sheet having an array of bubbles therein, slitting a first portion of the sheet to define longitudinal flaps but not slitting a second portion;
forming the second portion into a tubular sleeve; and
tucking at least one of the flaps into the tubular sleeve to form a bent vertical support structure for receiving and supporting stored product, the bent vertical support structure including bubbles on each side and having sufficient structure to support a stem extending laterally from the stored product.

4. A method of packing product for shipping comprising steps of:
providing a bubble sheet with a first portion defining a sleeve and a second portion forming flaps that can be folded into the sleeve; at least a first one of the flaps being positioned in the sleeve to define a support structure adapted to support a stem extending laterally from the product;
placing a first product into the sleeve with an associated stem of the first product support by the support structure;
folding a second one of the flaps onto the associated stem of the first product; and
placing a second product into the sleeve with an associated stem of the second product resting on the support structure and positioned generally adjacent the stem of the first product but separated therefrom by the second flap.

5. A packaging article comprising:
two layers of sheet material bonded together along continuous longitudinal and transverse weld lines to define an array of air-containing bubbled areas separated by non-bubbled strips, with at least one of the longitudinal and transverse weld lines each including one of the bubbled areas on one side and a non-bubbled area on an opposite side, with the non-bubbled strips facilitating folding; a first portion of the sheet being formed into a sleeve and a second portion of the sheet being slit to form flaps that fold into the sleeve to support product for shipment.

6 The article defined in claim 5, wherein the bubbled areas and the non-bubbled strips are elongated, and also the non-bubbled strips are about half a width of the bubbled areas.
